(19) United States
(12) Patent Application Publication
(10) Pub. No.: US 2011/0123969 A1
(43) Pub. Date: May 26, 2011

(54) REFUSAL SKILLS TRAINING EDUCATIONAL TOOL AND METHOD OF PRACTICING REFUSAL SKILLS

(75) Inventors: Timmothy Allen Boettcher, Altoona, WI (US); Jeremiah Robert Bauer, Mondovi, WI (US); Randy James Lee, Ridgeland, WI (US); Scott Todd Allison, Brooklyn Park, MN (US)

(73) Assignee: REALITYWORKS, INC, Eau Claire, WI (US)

(21) Appl. No.: 12/674,075

(22) PCT Filed: Aug. 22, 2008
(86) PCT No.: PCT/US08/74005

§ 371 Date: Feb. 14, 2011

Related U.S. Application Data
(60) Provisional application No. 60/957,326, filed on Aug. 22, 2007.

(51) Int. Cl. G09B 19/00

(52) U.S. Cl. 434/238

(57) ABSTRACT

A portable refusal skills training educational tool including an interactive electronic system within an enclosure, and method practicing refusal skills employing the educational tool. The interactive electronic system includes (i) a means within the enclosure for periodically generating a perceptible proposal to participate in addictive behavior, (ii) a speech recognition system effective for receiving and identifying a verbal refusal statement spoken in response to a generated proposal, and (iii) a reporting mechanism. The reporting mechanism includes at least one of (A) a means for reiterating perceptible proposals to participate in addictive behavior until the verbal refusal statement is received and identified in response to a proposal, (B) a means for generating a perceptible positive-reinforcement signal when the verbal refusal statement is received and identified in response to a proposal, and (C) a means for recording data useful in evaluating responses to proposals.

This application claims the benefit of U.S. Provisional Application No. 60/957,326, filed Aug. 22, 2007.

### BACKGROUND

It is well documented that the use of an addictant (e.g., alcohol, tobacco, heroin, etc.) is accompanied by undesirable physical and financial side-effects, with extended use resulting in severe health consequences and even an early death. Despite these dire facts, vast numbers of teenagers and young adults are persuaded or coerced into participating in addictive behavior each day (e.g., ingesting alcohol, smoking or chewing tobacco or shooting heroin) with many developing a physical and/or psychological addiction to the addictant and suffering the well-documented consequences of such addiction.

Accordingly, a substantial need exists for an educational tool capable of assisting teenagers and young adults in resisting the persuasive and coercive efforts of others to start participating in addictive behavior.

### SUMMARY OF THE INVENTION

A first aspect of the invention is a refusal skills training educational tool. The educational tool includes an enclosure and an interactive electronic system within the enclosure. The interactive electronic system includes (i) a means within the enclosure for periodically generating a perceptible proposal to participate in addictive behavior, (ii) a speech recognition system effective for receiving and identifying a verbal refusal statement spoken in response to a generated proposal, and (iii) a reporting mechanism. The reporting mechanism includes at least one of (A) a means for reiterating perceptible proposals to participate in addictive behavior until the verbal refusal statement is received and identified in response to a proposal, (B) a means for generating a perceptible positive-reinforcement signal when the verbal refusal statement is received and identified in response to a proposal, and (C) a means for recording data useful in evaluating responses to proposals.

The means for periodically generating a perceptible proposal to participate in addictive behavior preferably generates at least one invitation to participate in addictive behavior followed by at least one persistence inquiry, with a sufficient time interval between the invitation and the persistence inquiry to permit the speech recognition system to independently receive and identify a refusal statement for each proposal.

A first embodiment of a second aspect of the invention is a method of practicing refusal skills employing the educational tool of the first aspect of the invention. The method includes the steps of (i) taking possession of an educational tool comprising the first aspect of the invention, (ii) activating the speech recognition system to initiate a set-up routine wherein the speech recognition system can receive a verbal refusal statement, convert the verbal refusal statement into electrical signals and code the electrical signals for subsequent use in identifying a subsequently received verbal refusal statement, (iii) speaking a verbal refusal statement into the speech recognition system with the speech recognition system in the set-up routine, (iv) perceiving a proposal to participate in addictive behavior generated by the educational tool, (v) activating the speech recognition system in response to the proposal and speaking the refusal statement, and (vi) repeating steps (iv) and (v) periodically throughout an assignment period.

A second embodiment of the second aspect of the invention is a refusal skills training method, comprising the steps of (i) automatically generating a perceptible proposal to participate in addictive behavior from a portable electronic educational tool, (ii) reiterating proposals from the portable electronic educational tool to participate in addictive behavior throughout at least a demand period until a verbal refusal statement is received and identified from an individual in response to a proposal, and (iii) repeating steps (a) and (b) periodically throughout an assignment period.

The method preferably includes at least two sequential perceived proposals with one comprising an invitation to participate in addictive behavior followed by a persistence inquiry.

The method also preferably includes the step of transferring custody of the educational tool to a supervisor upon conclusion of the assignment period for review of recorded performance data.

### BRIEF DESCRIPTION OF THE DRAWINGS

FIG. 1 is a perspective view of one embodiment of the first aspect of the invention.

FIG. 1A is a front view of the invention depicted in FIG. 1.

FIG. 1B is a back view of the invention depicted in FIG. 1.

FIG. 1C is a right side view of the invention depicted in FIG. 1.

FIG. 1D is a left side view of the invention depicted in FIG. 1.

FIG. 1E is a top view of the invention depicted in FIG. 1.

FIG. 1F is a bottom view of the invention depicted in FIG. 1.

FIG. 2 is an electrical schematic of the invention depicted in FIG. 1.

FIG. 3 is a perspective view of an optional tamper-indicating identification wristband useful in combination with the educational tool of the first aspect of the invention for ensuring that the individual to whom the educational tool was assigned is involved in interactions with the educational tool.

FIG. 4 is an exemplary performance report generated from data recorded by the invention during an assignment period.

### DETAILED DESCRIPTION OF ONE EMBODIMENT OF THE INVENTION INCLUDING A BEST MODE

### Nomenclature

10 Refusal Skills Training Educational Tool
20 Case or Enclosure
20a Front of Enclosure
20b Back of Enclosure
20c Right Side of Enclosure
20d Left Side of Enclosure
20e Top of Enclosure
20f Bottom of Enclosure
25 Speaker Grill
26 Microphone Grill
30 Microcontroller, Microprocessor or Integrated Circuit
35 Random Access Memory Chip
40 Status Indicators
41 Power On/Off Indicator
42 Event Cycle On/Off Indicator
50 Speaker
60 Microphone
70 Talk Button
80 Volume Control Buttons
81 Up Volume Button
82 Down Volume Button
90 Radio Frequency Receiver
100 Port
200 Identification Wristband
210 Tamper-Indicating Band
290 RFID Tag or Wireless Identification Chip
B Power Supply or Battery

### DEFINITIONS

As utilized herein, including the claims, the phrase “assignment period,” means the period of time during which the educational tool is activated and the assigned student is given custody of the educational tool (e.g., an hour, an eight hour day, overnight, 48 hours, one week, etc.).

As utilized herein, including the claims, the phrase “interactive event,” means a temporally discrete single proposal or series of contemporaneous proposals to participate in addictive behavior and any responsive verbal refusal statement(s).

As utilized herein, including the claims, the phrase “proposal,” collectively refers to invitations to participate and persistence inquiries.

As utilized herein, including the claims, the phrase “refusal statement” means a verbal statement declining a proposal.

As utilized herein, including the claims, the term “timely” means before a time limit expires.

As utilized herein, including the claims, the phrase “random variable” is used in accordance with the dictionary definition of random variable (i.e., a variable that is a function of the result of a statistical experiment in which each outcome has a definite probability of occurrence, such as the number of spots showing if two dice are thrown). The phrase “bounded random variable” means that the random variable must fall within defined minimum and maximum values (i.e., the variable must greater than 0 and less than 13.)

As utilized herein, including the claims, the phrase “speech recognition system” means a system capable of converting sounds, words or phrases spoken by humans into electrical signals and transforming those electrical signals into coding patterns which can be used to identify the sound, word or phrase.

### Structure

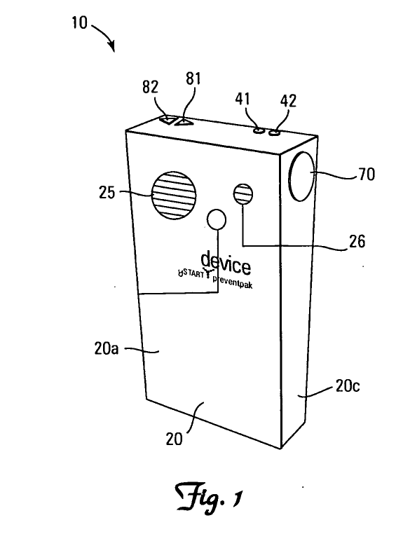

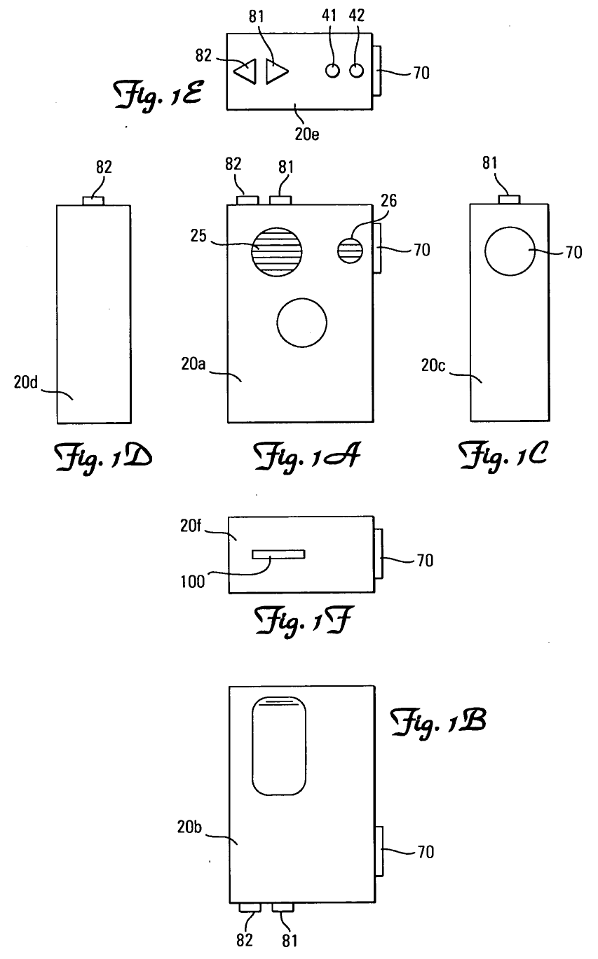

As shown in FIGS. 1, 1A-F and 2, a first aspect of the invention is an educational tool 10 useful for providing an individual (not shown), such as a middle school or high school student, with an interactive experience in resisting efforts by others to persuade and/or coerce them into participating in addictive behavior. The addictive behavior can be selected from any of the potentially self-destructive addictive activities including specifically, but not exclusively, ingesting alcohol, smoking cigarettes, chewing tobacco, taking illegal drugs, etc. Without intending to be limited thereby, the balance of the disclosure shall be provided in connection with an educational tool 10 directed to the addictive behavior of smoking cigarettes.

The educational tool 10 includes an enclosure 20 and an interactive electronic system (not collectively numbered) housed within the enclosure 20.

Enclosure 20

Referring to FIGS. 1 and 1A-F, the case or enclosure 20 is formed of a rigid structural material (e.g., glass, metal, paperboard, plastic, wood, etc.) and houses the mechanical and electrical components which comprise the active components of the educational tool 10. The enclosure 20 may be sized and shaped as desired, but should be sized to comfortably fit within a pocket or purse, and is preferably shaped to represent the customary packaging of the addictant simulated by the educational tool 10 (e.g., a pack of cigarettes, a can of chewing tobacco, a liquor bottle, a package of hypodermic needles, etc.). The intent is to enhance the connection between the addictant and the program in the mind of the student assigned to the educational tool 10.

The exemplary enclosure 20 depicted in FIGS. 1 and 1A-F is a rectangular enclosure 20 having the size and shape of a standard pack of cigarettes. The enclosure 20 includes a front 20a, back 20b, right side 20c, left side 20d, top 20e and bottom 20f.

The enclosure 20 includes a speaker grill 25 aligned with an internally mounted speaker 60 and a microphone grill 26 aligned with an internally mounted microphone 70. The exemplary enclosure 20 depicted in FIGS. 1 and 1A-F provides these grills 25 and 26 on the front 20a of the enclosure 20.

Sleeve (not Shown)

An inexpensive disposable sleeve (not shown) constructed from a material such as cardboard, paper or plastic can optionally be provided for protectively covering the enclosure 20 and allowing a student assigned to the educational tool 10 to customize the appearance of the educational tool 10. The top of the sleeve preferably flips opens—like a hardpack of cigarettes—for permitting access to the various interactive buttons on the educational tool 10 and uncovering the speaker 60 and microphone 70. The fliptop can also protect the interactive buttons from being inadvertently pressed, and assists in keeping the enclosure 20 clean.

Microcontroller 30

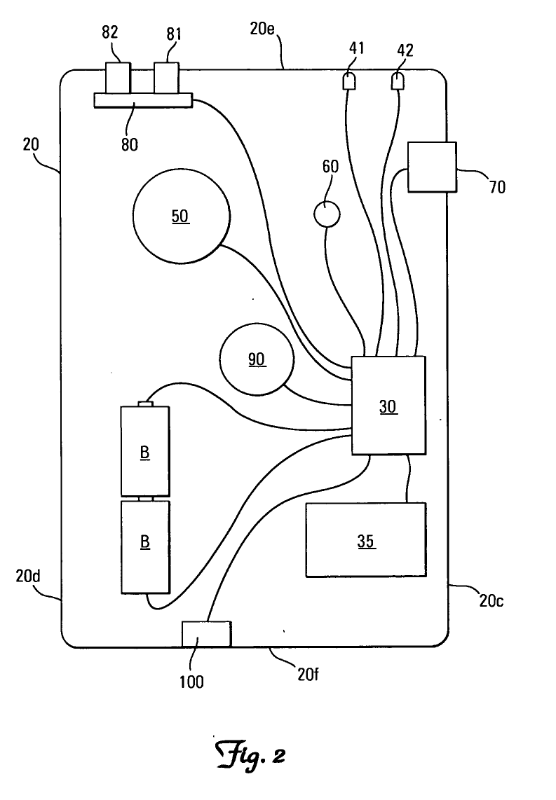

Referring to FIG. 2, the educational tool 10 includes a microcontroller 30 equipped with speech recognition and speech synthesis functionality. The microcontroller 30 is capable of sensing and recognizing speech, as well as generating spoken commands and messages. Microcontroller 30, equipped with speech recognition and speech synthesis functionality, can be selected from a wide variety of such microcontrollers available from a number of sources. One suitable microcontroller 30 is an RSC-4128 microcontroller and speech processing circuit manufactured by Sensory, Incorporated, 521 East Weddell Drive, Sunnyvale, Calif. 94089. The specific function and features of a microcontroller 30 with speech recognition and speech synthesis functionality is more fully described in U.S. Pat. No. 5,790,754, issued to Mozer et al.

The microcontroller 30 can employ either a Speaker Dependant (SD) or a Speaker Independent (SI) recognition subroutine for storing and verifying verbal statements, with SD subroutines capable of recognizing specific verbal statements and distinguishing between individual speakers, while SI subroutines are capable of recognizing specific verbal statements no matter who says them. The microcontroller 30 also includes Speech Synthesis (SS) subroutines for playing back prerecorded words, phrases, or lengthy messages. The microcontroller 30 can optionally include Continuous Listening Recognition (CLR) subroutines for recognizing specific verbal statements that may occur at unpredictable times.

The microcontroller 30 includes a timer (not shown), and preferably includes a real-time clock (not shown). The clock need not be particularly accurate (e.g., plus or minus thirty minutes). The clock permits the microcontroller 30 to be programmed or setup to prevent the scheduling of initiation of interactive events that would otherwise be scheduled during “inappropriate” time periods such as bedtime or a wedding ceremony to be attended by the assigned student during an assignment period. It also allows reports generated from the data recorded by the microcontroller 30 to provide temporal information as date and time of day rather than simply lapsed time as most individuals are more comfortable with the former format.

The microcontroller 30 also includes an external memory interface that allows connection to a standard nonvolatile static random access memory chip 35.

Status Indicators 40

The educational tool 10 can include a pair of status indicators 40 on the enclosure 20 for indicating the operational status of the educational tool 10. A first status indicator 41 can indicate the power status of the educational tool 10 (e.g., an LED that emits light when the educational tool is ON or AWAKE and does not emit light when the educational tool is OFF or ASLEEP). A second status indicator 42 can indicate the activity status of the educational tool 10 (e.g., an LED that emits light during each interactive event and does not emit light during the time intervals between interactive events).

Of course, other types of status indicators 40 can be employed in addition to or as an alternative to a visually perceptible indicator 40, such as an LCD alphanumeric or graphics display (not shown), an audible indicator (not shown) (e.g., a unique tone provided whenever the educational tool 10 powers ON/AWAKE, powers OFF/ASLEEP, starts an interactive event and ends an interactive event), a tactile indicator (not shown) (e.g., a unique vibrational pattern provided whenever the educational tool 10 powers ON/AWAKE, powers OFF/ASLEEP, starts an interactive event and ends an interactive event), etc. The specific educational tool 10 depicted in FIGS. 1, 1A-F and 2 employs LED status indicators 40 visible through the top 20e of the enclosure 20.

Speaker 50

Audio output is provided via speaker 50 in electrical communication with the microcontroller 30. The speaker 50 is housed within the enclosure 20 and aligned with speaker grill 25 in the enclosure 20. The specific educational tool 10 depicted in FIGS. 1, 1A-F and 2 positions the speaker 50 near the top 20e of the enclosure 20 directed forward for sending audio signals through a speaker grill 25 in the front 20a of the enclosure 20.

Microphone 60

Audio input is provided via microphone 60 in electrical communication with the microcontroller 30. The microphone 60 is housed within the enclosure 20 and aligned with microphone gill 26 in the enclosure 20. The specific educational tool 10 depicted in FIGS. 1, 1A-F and 2 positions the microphone 60 near the top 20e of the enclosure 20 directed forward for receiving audio signals through a microphone grill 26 in the front 20a of the enclosure 20.

Talk Button 70

A talk button 70 in electrical communication with the microcontroller 30 is provided on the educational tool 10 for activating the SD or SI subroutines for receipt and recognition of spoken words or phrases while the talk button 70 is pressed. The specific educational tool 10 depicted in FIGS. 1, 1A-F and 2 positions the talk button 70 on the right side 20c of the enclosure 20 near the top 20e.

Volume Control Buttons 80

Volume control buttons 80 (e.g., a volume UP button 81 and a volume DOWN button 82) in electrical communication with the microcontroller 30 are provided on the educational tool 10 for allowing a user to customize audio volume. The specific educational tool 10 depicted in FIGS. 1, 1A-F and 2 positions the volume control buttons 80 on the top 20e of the enclosure 20 near the left side 20d.

Radio Frequency Receiver 90

The microcontroller 30 can be programmed so that a unique identification signal must be received before a verbal refusal statement will be recognized. The specific educational tool 10 depicted in FIGS. 1, 1A-F and 2 employs a radio frequency receiver 90 in communication with the microcontroller 30 for receiving and communicating an identification signal to the microcontroller 30 from an RFID tag 290. Upon receipt of a matching signal from an RFID tag 290, the receiver 90 transmits a signal to the microcontroller 30 indicating that the RFID tag 290 “attached” to the assigned student is present, and thereafter allowing the microcontroller 30 to receive the verbal refusal statement.

Port 100

A port 100 is provided on the educational tool 10 for facilitating communication between the microcontroller 30 and a personal computer (not shown) during the setup and reporting modules. The specific educational tool 10 depicted in FIGS. 1, 1A-F and 2 provide the port 100 on the bottom 20f of the enclosure 20.

Batteries B

The educational tool 10 needs to be portable and therefore includes an onboard power supply, such as a set of batteries B wired in series.

Identification System

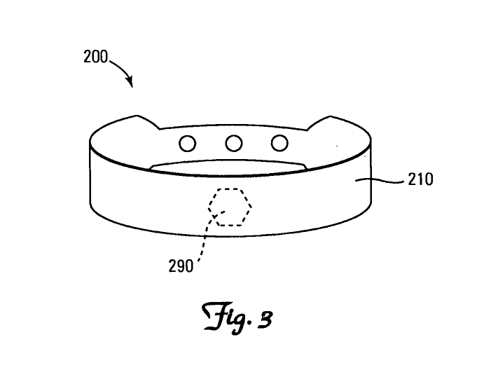

Referring to FIGS. 2 and 3, in order to ensure that the student assigned to interact with the educational tool 10 is at least present when verbal refusal statements are spoken into the educational tool 10 in response to a proposal to participate in addictive behavior generated by the educational tool 10, the educational tool 10 can be equipped with an identification system (not collectively referenced). The identification system prevents the educational tool 10 from receiving and recognizing a refusal statement until an identification signal is received by the identification system.

An exemplary identification system includes at least a means 90 in communication with the microcontroller 30 for receiving an identification signal personal to the assigned student and providing a signal to the microcontroller 30 indicating receipt of the identification signal.

The means 90 for receiving an identification signal personal to the assigned student can be any of a number of systems or devices capable of identifying and responding only to a unique item or characteristic possessed by the assigned student. A nonexhaustive list of such devices includes (i) a fingerprint recognition device (not shown), (ii) a voice recognition device (not shown), (iii) a keyhole (not shown) accepting a uniquely shaped identification key (not shown) attachable to the wrist of the assigned student by a tamper indicating bracelet (not shown), and (iv) a radio frequency identification device (RFID) 200 with the RFID tag 290 attachable to the wrist of the assigned student by a tamper indicating wristband 210.

### Programming and Use

Setup Mode

Prior to each assignment period each educational tool 10 needs to be setup for purposes of at least (i) establishing the assignment period, (ii) establishing the number and/or frequency of interactive events during the assignment period, and (iii) correlating the educational tool 10 to an assigned student so that performance data reported by the educational tool 10 upon conclusion of the assignment period can be attributed and reported to the proper student.

Setup is preferably performed via a personal computer (not shown) upon which the necessary setup software has been loaded. The microcontroller 30 on the educational tool 10 can be conveniently connected to a personal computer via port 100 on the educational tool 10 using a docking station (not shown) cabled to the computer (not shown).

Assignment Period

The duration of the assignment period can be selected by the program administrator as desired. For example, the assignment period can be set for a single hour when use is to be confined to a single classroom setting, or the assignment period can be set for a 24 hour period when the assigned student(s) are scheduled to return to the classroom the next day. The program administrator can set the assignment period by establishing a time of day start and stop time (e.g., start at 3:00 pm on Monday the 1^{st} and end at 3:00 pm on Tuesday the 2^{nd}) or lapsed time (e.g., 24 hours).

The program administrator can also program each educational tool 10 to power OFF or SLEEP during defined time periods within an assignment period (e.g., SLEEP from 11:00 pm to 7:00 am).

Frequency of Interactive Events

The time interval between interactive events can be (i) regular intervals established by dividing the duration of the assignment period minus any SLEEP periods by the desired number of interactive events, (ii) regular intervals established as a single set value (e.g., every 45 minutes), (iii) a bounded random variable (e.g., occurring every 30 to 120 minutes), or (iv) a predetermined variable (e.g., sequentially occurring at intervals of 30, 90, 30, 30, 120, 60, 20 and 90 minutes).

In order to more accurately emulate the addictive cravings, and prevent students from memorizing the schedule of events, it is generally preferred to control the time interval between events as a bounded random variable. Alternatively, multiple predefined programs, each providing a different fixed schedule of events, can also be realistically employed so long as the students do not know which program has been selected (i.e., the schedule of events is random from the perspective of the student) and the number of programs is sufficient to prevent the students from memorizing one or two different schedules and thereafter being able to partially defeat the purpose of the program by refusing to carry the educational tool 10 between scheduled events.

Speech Recognition Mode

In order for the speech recognition system to identify a verbal refusal statement spoken by an assigned student, the system needs to be conditioned to recognize the verbal refusal statement. Conditioning of the system involves receiving the verbal refusal statement from the assigned student, converting the verbal refusal statement into electrical signals, coding the electrical signals, and recording the coded electrical signals in memory for subsequent use as a baseline in recognizing subsequently received verbal refusal statements.

Hence, prior to moving into the initiation module the educational tool 10 requests that the assigned student provide the speech recognition system with his/her verbal refusal statement(s)—including the primary and any secondary verbal refusal statements. In response to such a request the assigned student need merely press the talk button 70, state the refusal statement into the microphone 60, and release the talk button 70. This process can be repeated for each verbal refusal statement. The educational tool 10 preferably acknowledges successful recording of each verbal refusal statement.

Initiation Mode

Once the educational tool 10 has been setup and the verbal refusal statement(s) recorded in memory 35, the educational tool 10 can be activated to commence an assignment period. Upon activating the educational tool 10, the microcontroller 30 begins timing the assignment period, and begins timing the intervals between successive proposals to participate in addictive behavior based upon the program selected and/or preprogrammed into the microcontroller 30.

Interactive Event Mode

The microcontroller 30 can optionally initiate each scheduled interactive event with a declaration of intent to undertake addictive behavior (e.g., an announcement of the need for a cigarette and the intent to satisfy that need). The specific educational tool 10 depicted in FIGS. 1, 1A-F and 2 provides the declaration of intent as a verbal declaration through the speaker 50. Exemplary declarations of intent related to cigarette smoking are listed below in Table One. The voice extending the declaration of intent can be given a personality, preferably a personality selected from a list of possible personalities by the person administering the program or the assigned student. A nonexhaustive list of personalities include specifically, but not exclusively, authoritative, bully, cool, humorous, sarcastic, motherly, scientific, etc. The voice extending the declaration of intent can also be ascribed to a specific demographic, such as a teenage peer group, a young male adult, a young female adult, etc.

TABLE ONE
Declarations of Intent to Participate in Addictive Behavior

I'm craving a cigarette.
I wanna smoke.
I need a smoke break.
I'm stressed - I need a cigarette.
I'm having a bad day - I need a smoke.
I need a cigarette.
I've got a lot on my mind - I really need a cigarette.
Man, I want a cigarette.
I can't take it anymore - I need a cigarette.
I need a smoke break
I want a cigarette.
I really need a cigarette.
My craving isn't going away - I need a cigarette.
I need to light up.
I'm so stressed - I really need to go smoke.
My day is getting worse - I really need a cigarette.
I can only relax after I have a smoke.
I wanna smoke now!

When a declaration of intent is employed, the declaration of intent is followed by an invitation to participate in addictive behavior. When a declaration of intent is not employed, then each scheduled interactive event can be initiated by the invitation to participate in addictive behavior. The specific educational tool 10 depicted in FIGS. 1, 1A-F and 2 provides the invitation as a verbal invitation through the speaker 50. Exemplary invitations related to cigarette smoking are listed below in Table Two. As with the voice providing the declaration of intent, the voice extending the invitation can be given a personality, preferably a personality selected from a list of possible personalities by the person administering the program or the assigned student.

TABLE TWO
Invitations to Participate in Addictive Behavior

You can bum a cigarette from me.
What do you mean you've never had a cigarette. Try one.
Wanna join us for a cigarette?
We can get you a pack of cigarettes at the Quick and Pick, they'll sell to
anyone. You got five bucks?
Have a smoke.
These menthol cigarettes are great. Wanna try one?
Cigarette?
Why do you hang with those losers? I'll bet they've never even touched a
cigarette. Want to try one?

When the educational tool 10 is equipped with the identification feature, the microcontroller 30 must receive an electronic signal from the identification means 90 indicating receipt of the identification signal from the assigned student before a verbal refusal statement will be recognized (e.g., the assigned student must place the RFID tag 290 in the wristband 210 attached to his/her wrist against the enclosure 20 proximate the radio frequency receiver 90 within the enclosure 20). Upon receipt of the identification signal, the identification means (e.g., a radio frequency receiver 90) will transmit a signal to the microcontroller 30 indicating that the assigned student is present, and thereafter allow the microcontroller 30 to receive the verbal refusal statement.

If the microcontroller 30 timely receives and recognizes a verbal refusal statement, the microcontroller 30 records a successful response. If a verbal refusal statement is not timely received and recognized by the microcontroller 30, the microcontroller 30 records an unsuccessful response.

The time limit for treating receipt and recognition of a verbal refusal statement as timely need only be long enough to permit an assigned student to retrieve the educational tool 10, recall the appropriate verbal refusal statement, press the talk button 80 and speak the verbal refusal statement into the microphone 70 (e.g., about 30 seconds), and should be short enough to ensure that the assigned student is indeed responding to the proposal and not just periodically providing the educational tool 10 with a verbal refusal statement on the student's own schedule (e.g., less than ten minutes). A practical time limit is between about 2 and 4 minutes.

In a preferred embodiment, the microcontroller 30 is programmed to provide a persistence inquiry to participate in addictive behavior shortly after receiving and recognizing a timely refusal statement to the invitation. Persistence inquiries can be extended by the same or a different voice and personality as the invitation, and can be the same or a different statement as the invitation. Persistence inquiries preferably respond to the assigned student's initial refusal to participate in the addictive behavior and ask “why not?”. Exemplary persistence inquiries related to cigarette smoking are listed below in Table Three.

TABLE THREE
Persistence Inquiries to Participate in Addictive Behavior

Why not? Everyone does!
Why not? I thought you were cool!
Why not? you chicken?
What's the deal, why not?

If the microcontroller 30 timely receives and recognizes a verbal refusal statement in response to the persistence inquiry, the microcontroller 30 continues to record a successful response. However, if a verbal refusal statement is not timely received in response to the persistence inquiry, the microcontroller 30 should change the previously recorded successful response to an unsuccessful response.

The microcontroller 30 preferably reiterates proposals to participate in addictive behavior several times over several minutes—with each proposal requiring a timely response of a verbal refusal statement—to mimic real-life situations in which those making such proposals do not stop after a single attempt, but repeat the proposals throughout their participation in the addictive behavior (e.g., up to fifteen proposals within an approximately four minute time span).

In a preferred embodiment, the verbal refusal statement(s) accepted as an appropriate response to an invitation to participate in addictive behavior is different from the verbal refusal statement(s) accepted as an appropriate response to a persistence inquiry. More specifically, the verbal refusal statement(s) accepted as an appropriate response to an invitation to participate in addictive behavior (hereinafter a primary verbal refusal statement) is preferably a rather perfunctory refusal statement (e.g., No, Nope, No way, No thanks, You must be kidding), while the verbal refusal statement(s) accepted as an appropriate response to a persistence inquiry (hereinafter a secondary verbal refusal statement) is preferably a “why not” statement supporting or explaining the primary verbal refusal statement that can be personal to the student. A nonexhaustive listing of possible secondary verbal refusal statements is provided in Table Four below.

TABLE FOUR
Secondary Verbal Refusal Statements

I don't wanna die.
I don't want bad breath
I don't want black lungs.
I don't want cancer.
I don't want to.
I don't want to be suspended.
I don't want wrinkles.
I hate the smell of tobacco.
I hate tobacco.
I have dreams.
I like a clean mouth.
I like clean air.
I like money in my pockets.
I like my freedom.
I like my smile.
I like to be in control.
I like to breathe easy.
I like to taste my food.
I like white teeth.
I wanna live my dreams.
I wanna live.
I wanna stay in school.
I want my friends to like me.
I'm not a human ashtray.
I'm too young for wrinkles.
Clean lungs rock.
Habits are hard to break.
Healthy lungs breathe easy.
Nicotine is addictive.
Nicotine is controlling.
Nicotine will control me.
Secondhand smoke stinks.
Smoking is gross.
Smoking is not glamorous.
Smoking is unattractive.
Tobacco can kill me.
Tobacco can kill you and me.
Tobacco causes cancer.
Tobacco causes gum disease.
Tobacco causes heart disease.
Tobacco causes strokes.
Tobacco costs a lot.
Tobacco increases heart rate.
Tobacco is dangerous.
Tobacco is gross.
Tobacco is hard to quit
Tobacco reduces energy.
Tobacco squashes dreams.
Tobacco sucks the life out of you.
Tobacco will slow me down.
Because I dance.
Because I play ball.
Because I play music.
Because I play sports.
Because I said NO.
Because I said so.
Because I sing.
Because I swim.
Cancer is a serious disease.
Heart disease kills.
Life is precious.
My dreams are important to me.
My friends don't hang out with smokers.
My friends don't smoke.
My friends think tobacco is gross.
My future is important.
My goals are important.
My life is too important.
My parents would kill me.
Who wants cancer?
Who wants gum disease?
Who wants heart disease?
Who wants to smell like an ashtray?
Why risk death?
Yellow teeth are gross.

Reporting Mode

Upon completion of an assignment period, the assigned student should return the educational tool 10 to the program administrator. Upon receiving the educational tool 10, the program administrator can connect the microcontroller 30 on the educational tool 10 to the personal computer used to setup the educational tool 10 via port 100 for downloading of relevant data from the microcontroller 30 and memory 35 onto the computer. Once downloaded, the computer can generate a variety of performance reports based upon the data.

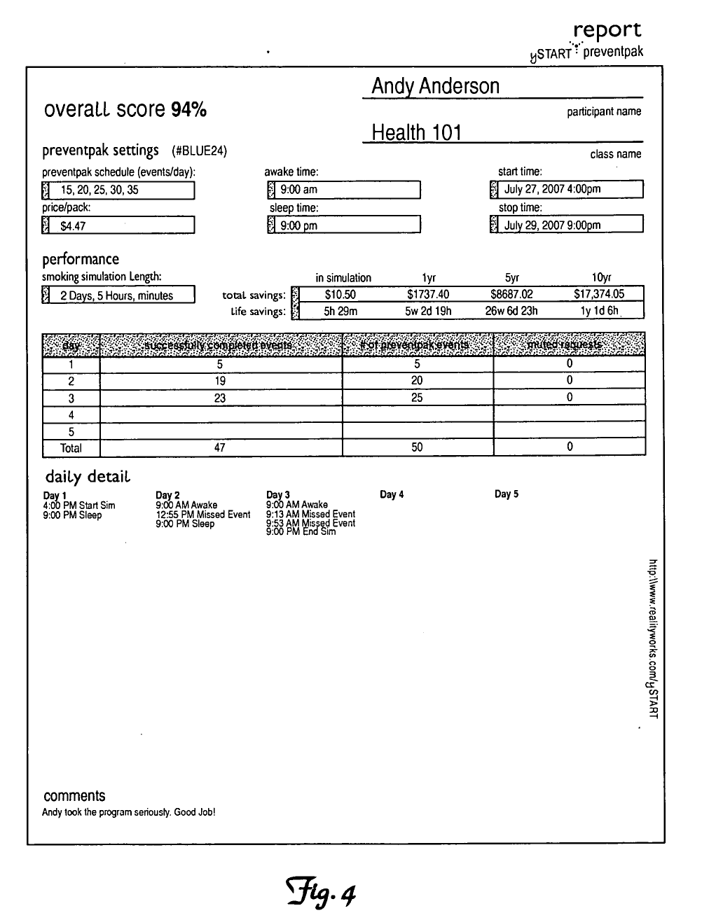

Information that may be provided on a performance report and communicated to the assigned student can include specifically, but not exclusively, (i) start and stop time of the assignment period, (ii) total duration of the assignment period, (iii) times during which the educational tool 10 was OFF/ASLEEP (i.e., times during which the educational tool 10 was programmed not to initiate interactive events), (iv) the total number of interactive events initiated by the educational tool 10 during the assignment period, optionally reported on a daily basis, (v) an indication of the money saved by not participating in the addictive behavior during the assignment period, calculated by multiplying the current unit price of the simulated addictant (e.g., cigarettes) by the number of interactive events during the assignment period, (vi) a projection of the money saved by not participating in the addictive behavior over an extended time period (e.g., 1 year, five years and 10 years), calculated by dividing the duration of the extended time period by the duration of the assignment period and multiplying the resultant quotient by the money saved by not participating in the addictive behavior during the assignment period, (vii) the number of interactive events to which the student successfully provided a timely response and those to which the student did not successfully provide a timely response, (viii) the percentage of interactive events to which the student successfully provided a timely response, and/or the percentage of interactive events to which the student did not successfully provide a timely response, (ix) an identification of the specific interactive events to which the student did not provide a timely response (e.g., date and time of the “missed” interactive events), etc. An exemplary performance report is depicted in FIG. 4.

1. A refusal skills training educational tool, comprising:
(a) an enclosure, and
(b) an interactive electronic system retained within the enclosure, including at least:
(1) a means for periodically generating a perceptible proposal to participate in addictive behavior,
(2) a speech recognition system effective for receiving and identifying a verbal refusal statement spoken in response to a generated proposal, and
(3) a reporting mechanism, comprising at least one of (i) a means for reiterating proposals to participate in addictive behavior until the verbal refusal statement is received and identified in response to a proposal, (ii) a means for generating a perceptible positive-reinforcement signal when the verbal refusal statement is received and identified in response to a proposal, and (iii) a means for recording data useful in evaluating responses to proposals.

2. The educational tool of claim 1 wherein (i) the means for periodically generating a perceptible proposal to participate in addictive behavior generates at least one invitation to participate in addictive behavior followed by at least one persistence inquiry, with a sufficient time interval between the invitation and the persistence inquiry to permit the speech recognition system to independently receive and identify a refusal statement for each proposal.

3. (canceled)

4. (canceled)

5. (canceled)

6. The educational tool of claim 1 wherein the enclosure has a size and shape indicative of a pack of cigarettes.

7. The educational tool of claim 1 wherein the enclosure has a size and shape of a pack of cigarettes and the tool further includes a disposable sleeve configured and arranged to encase the enclosure that is printed with indicia depicting cigarettes retained within a pack.

8. The educational tool of claim 1 wherein the means for periodically generating a perceptible proposal to participate in addictive behavior generates a plurality of perceptible proposals throughout an assignment period of predetermined duration.

9. The educational tool of claim 1 wherein the perceptible proposal is a verbal proposal.

10. The educational tool of claim 9 wherein the verbal proposal is a friendly invitation from a peer.

11. (canceled)

12. (canceled)

13. The educational tool of claim 1 wherein (i) the means for recording data useful in evaluating responses to proposals records at least (A) the total number of proposals, and (B) the number of proposals followed by timely receipt and identification of the verbal refusal statement.

14. The educational tool of claim 1 wherein (i) the speech recognition system must be manually activated after each proposal to receive a verbal refusal statement, and (ii) the means for recording data useful in evaluating responses to proposals records at least (A) the total number of proposals, (B) the number of proposals followed by timely manual activation of the speech recognition system, and (C) the number of proposals followed by timely receipt and identification of the verbal refusal statement.

15. The educational tool of claim 14 wherein the speech recognition system must be continuously manually activated during a verbal refusal statement to receive the verbal refusal statement.

16. The educational tool of claim 13 wherein the verbal refusal statement must be received in less than two minutes from generation of the proposal for receipt to be timely.

17. (canceled)

18. (canceled)

19. The educational tool of claim 1 further comprising a means for communicating a fact pertaining to the addictive behavior substantially contemporaneously with receipt and identification of a verbal refusal statement in response to a generated proposal, effective for reinforcing a decision to forgo participation in the addictive behavior.

20. The educational tool of claim 1 wherein the reporting mechanism is a means for reiterating proposals to participate in addictive behavior until the verbal refusal statement is received and identified in response to an invitation.

21. The educational tool of claim 1 wherein the reporting mechanism is a means for generating a perceptible positive-reinforcement signal when the verbal refusal statement is received and identified in response to a proposal.

22. The educational tool of claim 1 wherein the reporting mechanism is a means for recording data useful in evaluating responses to proposals.

23. A method of practicing refusal skills, comprising:
(a) taking possession of a educational tool for an assignment period, wherein the educational tool comprises at least:
(1) an enclosure,
(2) a means within the enclosure for periodically generating a perceptible proposal to participate in addictive behavior,
(3) a speech recognition system within the enclosure effective for receiving and identifying a predetermined verbal refusal statement in response to a generated proposal, and
(4) a reporting mechanism, comprising at least one of (i) a means for reiterating perceptible proposals to participate in addictive behavior until the verbal refusal statement is received and identified in response to a proposal, (ii) a means for generating a perceptible positive-reinforcement signal when the verbal refusal statement is received and identified in response to a proposal, and (iii) a means for recording data useful in evaluating responses to proposals,
(b) activating the speech recognition system to initiate a set-up routine wherein the speech recognition system can receive a verbal refusal statement, convert the verbal refusal statement into electrical signals and code the electrical signals for subsequent use in identifying a subsequently received verbal refusal statement,
(c) speaking a verbal refusal statement into the speech recognition system with the speech recognition system in the set-up routine,
(d) perceiving a proposal to participate in addictive behavior generated by the educational tool,
(e) activating the speech recognition system in response to the proposal and speaking the refusal statement, and
(f) repeating steps (d) and (e) periodically throughout an assignment period.

24. The method of claim 23 further comprising the step of transferring custody of the educational tool to a supervisor upon conclusion of the assignment period.

25. The method of claim 23 wherein the reporting mechanism is a means for reiterating proposals to participate in addictive behavior until the verbal refusal statement is received and identified in response to a proposal.

26. The method of claim 23 wherein the reporting mechanism is a means for generating a perceptible positive-reinforcement signal when the verbal refusal statement is received and identified in response to a proposal.

27. The method of claim 23 wherein the reporting mechanism is a means for recording data useful in evaluating responses to proposals.

28. The method of claim 23 further comprising the step of receiving a report of data recorded by the educational tool during the assignment period.

29. (canceled)

30. (canceled)

31. (canceled)

32. (canceled)

33. The method of claim 23 wherein the perceptible proposal is a verbal proposal.

34. The method of claim 33 wherein the verbal proposal is a friendly invitation from a peer.

35. The method of claim 28 wherein the report includes at least (A) the total number of proposals generated by the educational tool, and (B) the number of proposals followed by timely receipt and identification of the predetermined verbal refusal statement.

36. The method of claim 35 wherein the predetermined verbal refusal statement must be received within less than two minutes from generation of the proposal to be timely.

37. The method of claim 23 wherein the assignment period is at least four hours in duration.

38. The method of claim 23 wherein the assignment period is at least twenty four hours in duration.

39. (canceled)

40. A refusal skills training method, comprising:
(a) automatically generating a perceptible proposal to participate in addictive behavior from a portable electronic educational tool,
(b) reiterating proposals from the portable electronic educational tool to participate in addictive behavior throughout at least a demand period until a verbal refusal statement is received and identified from an individual in response to a proposal, and
(c) repeating steps (a) and (b) periodically throughout an assignment period.

41. The method of claim 40 wherein the perceptible proposal is a verbal proposal.

42. The method of claim 41 wherein the verbal proposal is a friendly invitation from a peer.

43. The method of claim 40 wherein the demand period is at least four minutes in duration.

44. (canceled)

45. (canceled)
